(19) United States
(12) Patent Application Publication
(10) Pub. No.: US 2009/0032498 A1
(43) Pub. Date: Feb. 5, 2009

(54) Spin Processing Method And Apparatus

(75) Inventors: Masato Tsuchiya, Gunma (JP); Syunichi Ogasawara, Gunma (JP); Katsumi Nezu, Gunma (JP)

Correspondence Address: MARGER JOHNSON & MCCOLLOM, P.C., 210 SW MORRISON STREET, SUITE 400, PORTLAND, OR, 97204, US

(73) Assignee: MIMASU SEMICONDUCTOR INDUSTRY CO., LTD., Takasaki-shi, Gunma (JP)

(21) Appl. No.: 11/908,275

(22) PCT Filed: Mar. 30, 2005
(86) PCT No.: PCT/JP2005/006142

§ 371 Date: Sep. 10, 2007

(51) Int. Cl. C23F 1/00; B08B 3/10; C23F 1/08; B08B 13/00

(52) U.S. Cl. 216/92; 134/19; 156/345.17; 134/56 R

(57) ABSTRACT

There are provided a spin processing method and a spin processing apparatus with which the improvement of a processing speed in spin processing can be compatible with the saving of a processing solution. The spin processing method comprises holding and fixing the wafer on the upper surface of the spin table, and supplying the processing solution to the surface of the wafer by the predetermined amount while rotating the spin table, to process the surface of the wafer, wherein the processing solution is supplied while the wafer is heated and maintained at the predetermined temperature, to process the wafer. The predetermined temperature for heating the wafer is equal to or higher than 25° C.

### TECHNICAL FIELD

The present invention relates to a spin processing method and a spin processing apparatus with which a processing speed of spin processing such as spin etching processing or spin washing processing can be improved and a processing solution can be saved.

### BACKGROUND ART

In conventional spin processing, a method of increasing a temperature of a processing solution and holding a wafer temperature at a spin processing point is used.

An apparatus shown in FIG. 5 has been known as an apparatus for performing the conventional spin processing, for example, spin etching processing. In FIG. 5, reference numeral 10 denotes a conventional spin etching apparatus which includes a spin table 14 provided to be rotatable by a rotational shaft 12. A wafer holding means 16 for holding a wafer W is provided on an upper surface of the spin table 14. Reference numeral 18 denotes a chemical solution supply nozzle provided above the wafer holding means 16. The chemical solution supply nozzle 18 is connected with a chemical solution circulating and heating tank 22 through a connection pipe L1 to which a chemical solution pump P1 is provided. The chemical solution circulating and heating tank 22 has a function for storing an etching solution 20 and performing circulation and heating thereon.

Reference numeral 24 denotes a chemical solution supply bottle for storing the etching solution 20, which is connected with the chemical solution circulating and heating tank 22 through a connection pipe L2 to which a pump P2 is provided and which acts to replenish the etching solution when the etching solution stored in the chemical solution circulating and heating tank 22 reduces. Reference numeral 26 denotes a heater means provided adjacent to the chemical solution circulating and heating tank 22, which is provided in a chemical solution circulating pipe L3 to which a circulating pump P3 is provided and which has a function for heating the etching solution circulating in the chemical solution circulating pipe L3. Reference numeral 28 denotes a temperature sensor which is provided so as to be able to be immersed in the chemical solution circulating and heating tank 22 and which detects a temperature of the etching solution 20 in the chemical solution circulating and heating tank 22.

The temperature sensor 28 is electrically connected with a temperature control circuit 30 through an electrical wire E1. The temperature control circuit 30 is electrically connected with the heater means 26 through an electrical wire E2. The heater means 26 is controlled based on a signal from the temperature control circuit 30, so the temperature of the etching solution 20 can be adjusted to a predetermined temperature.

According to the above-mentioned structure, the etching solution 20 which circulates in the chemical solution circulating and heating tank 22 and is maintained at the predetermined temperature is supplied from the chemical solution supply nozzle 18 to an upper surface of the wafer W by a predetermined amount, thereby performing predetermined spin etching processing. In the spin etching processing, the temperature of the etching solution 20 in the chemical solution circulating and heating tank 22 is continuously detected by the temperature sensor 28 and a detection temperature signal therefrom is sent to the temperature control circuit 30. The heater means 26 is controlled based on the signal from the temperature control circuit 30, so the etching solution 20 is maintained at the predetermined temperature.

However, in the above-mentioned spin etching apparatus, it is necessary to heat an etching solution required to process a predetermined number of wafers in a standby state, so deterioration with time of the etching solution during the standby state becomes a problem. The standby of the etching solution at a high temperature becomes a problem in view of not only deterioration with time but also safety.

There is another problem that the holding of the temperature at a spin etching processing point (upper surface of the spin table 14) requires an increase in the amount of etching solution to be supplied and the improvement of a processing speed directly leads to an increase in the amount of etching solution to be used. The above-mentioned conventional apparatus has a problem that an etching solution supplying circuit is complicated, thereby causing an increase in cost.

In order to increase the etching processing speed in the spin etching processing, it is necessary to adjust the temperature of the etching solution to a high temperature. In addition, in order to suppress a reduction in temperature at the etching processing point, it is necessary to increase a chemical solution flow rate. However, when the temperature of the etching solution is set to a high value in order to increase the etching processing speed, the etching solution which is not used and in the standby state deteriorates with time. In addition, in order to prevent the reduction in temperature at the etching processing point, the flow rate is increased, so it is necessary to supply the etching solution having an amount of equal to or larger than that required for processing. Therefore, there is a situation that the improvement of the etching processing speed cannot be compatible with the saving of the etching solution. Another spin processing such as spin washing processing has the same problems.

In addition to the above-mentioned method of controlling the temperature of processing solution such as the etching solution, a method of controlling an atmosphere temperature inside a container of a substrate processing apparatus has been known (Patent Document 1).

Patent Document 1: JP 2000-315671 A

### DISCLOSURE OF THE INVENTION

### Problems to be Solved by the Invention

The present invention has been made to solve the above-mentioned problems of the conventional technique and an object of the present invention is to provide a spin processing method and a spin processing apparatus with which the improvement of a processing speed in spin processing can be compatible with the saving of a processing solution.

### Means for Solving the Problems

To solve above-mentioned problems, a spin processing method according to the present invention is a spin processing method comprising holding and fixing a wafer on an upper surface of a spin table, and supplying a processing solution to a surface of the wafer by a predetermined amount while rotating the spin table, to process the surface of the wafer, wherein the processing solution is supplied while the wafer is heated and maintained at a predetermined temperature, to process the wafer.

The predetermined temperature for heating the wafer is preferably equal to or higher than 25° C., more preferably equal to or higher than 30° C., and most preferably equal to or higher than 35° C. An upper limit value of the temperature of the heated wafer may be high as long as the processing solution is not boiled. However, an upper limit temperature of a normal etching solution or washing solution is approximately 99° C. An appropriate amount of supply of processing solution is 1 L/min to 0.005 L/min. When the amount of supply exceeds 1 L/min, the temperature of the supplied processing solution influences the temperature control of the wafer, which is not preferable. When the amount of supply is smaller than 0.005 L/min, there may be the case where a processing effect is insufficient.

A spin processing apparatus according to the present invention comprises: a spin table rotatably provided and including wafer holding means on an upper surface thereof; a chemical solution supply nozzle for supplying a processing solution to the upper surface of the spin table; wafer heating means for heating a wafer held and fixed on the upper surface of the spin table; wafer temperature detecting means for detecting a temperature of the wafer; and a temperature control circuit for controlling the wafer heating means based on a detection temperature signal from the wafer temperature detecting means.

An N₂ hot jet means for spraying a pressurized and heated nitrogen gas, an air hot jet means for spraying pressurized and heated air, or an infrared spot light means for emitting infrared light in a spot-shaped manner can be used as the wafer heating means. In addition, it is possible to use a heating member (heater) with which a temperature can be adjusted, which is provided in the wafer holding means.

It is not the gist of the present invention is not to feed an etching solution adjusted to a high temperature in a standby state to a spin processing point (upper surface of the spin table) as in a conventional case, but to increase a temperature of a processed surface of the wafer at the spin a processing point to a temperature close to an upper limit temperature of each of the wafer and the processing solution to be used, thereby processing the wafer.

The processing solution (chemical solution) to be supplied in the present invention is supplied at a flow rate reduced to a minimum flow rate at which the processed surface of the wafer can be uniformly processed, thereby preventing a reduction in temperature of a surface processed by the processing solution (chemical solution). Such means is employed, so it is possible to increase a processing speed and save the amount of processing solution (chemical solution) to be used.

### EFFECTS OF THE INVENTION

According to the present invention, the temperature control is performed at the spin processing point, so there is no deterioration with time of the processing solution. Therefore, the temperature can be increased to a limit, with the result that the processing can be performed in a fastest chemical reaction condition. Thus, according to the present invention, an effect capable of improving a production capacity is obtained.

According to the present invention, even when a chemical solution flow rate is minimized, the temperature control is performed at the spin processing point, so there is no reduction in temperature. Therefore, when the chemical solution flow rate is smaller, the temperature control is more easily performed at the spin processing point, which is advantageous.

According to the present invention, the use efficiency of the chemical solution is improved, thereby reducing the amount of the chemical solution to be used. In addition, a chemical solution supply circuit is simplified, so a reduction in cost can be expected.

### BRIEF DESCRIPTION OF THE DRAWINGS

FIG. 1 is a schematic explanatory side diagram showing a structural example of a spin etching apparatus according to the present invention.

FIG. 2 is a schematic explanatory partial cross sectional diagram showing another structural example of the spin etching apparatus according to the present invention.

FIG. 3 is a graph showing a correlation between a hydrofluoric acid flow rate and an etching rate in Experimental Example 1.

FIG. 4 is a graph showing a correlation between a wafer surface temperature and an etching rate in Experimental Example 2.

FIG. 5 is a schematic explanatory side diagram showing a structural example of a conventional spin etching apparatus.

### DESCRIPTION OF SYMBOLS

10: a conventional spin etching apparatus, 11, 11a: spin processing apparatus of the present invention, 12: a rotational shaft, 14: a spin table, 16: a wafer holding means, 18: a chemical solution supply nozzle, 20: an etching solution, 22: a chemical solution circulating and heating tank, 24: a chemical solution supply bottle, 26: a heater means, 28: a temperature sensor, 30: a temperature control circuit, 32: a wafer heating means, 34: a wafer temperature detecting means, 35: an external power source, 36: a power supply brush, 38: an electrical wire, E1, E2, E3, E4: electrical wires, L1, L2, L4: connection pipes, L3: a chemical solution circulating pipe, P1, P2, P4: chemical solution pumps, P3: a circulating pump, W: a wafer

### BEST MODE FOR CARRYING OUT THE INVENTION

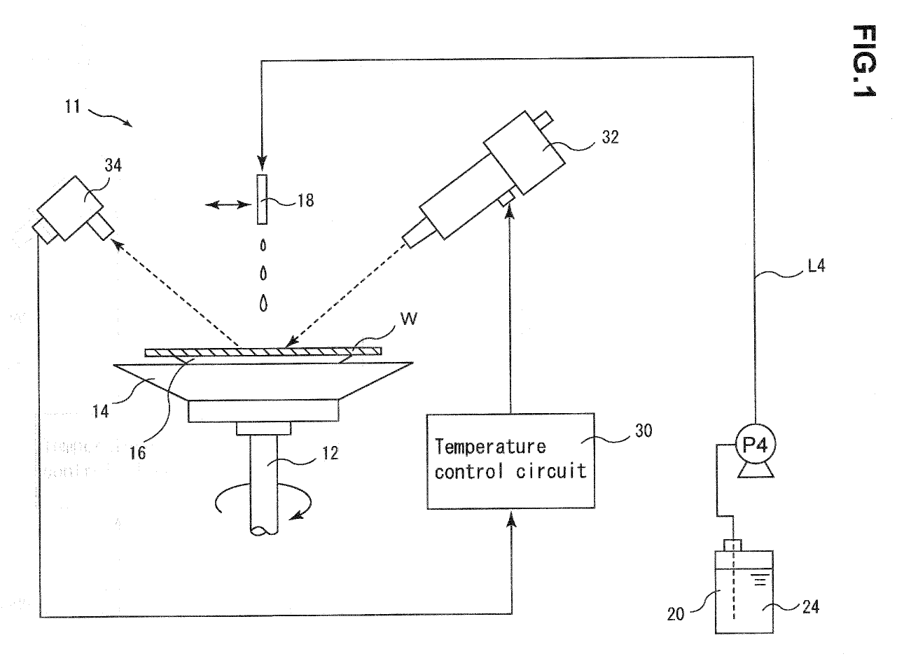

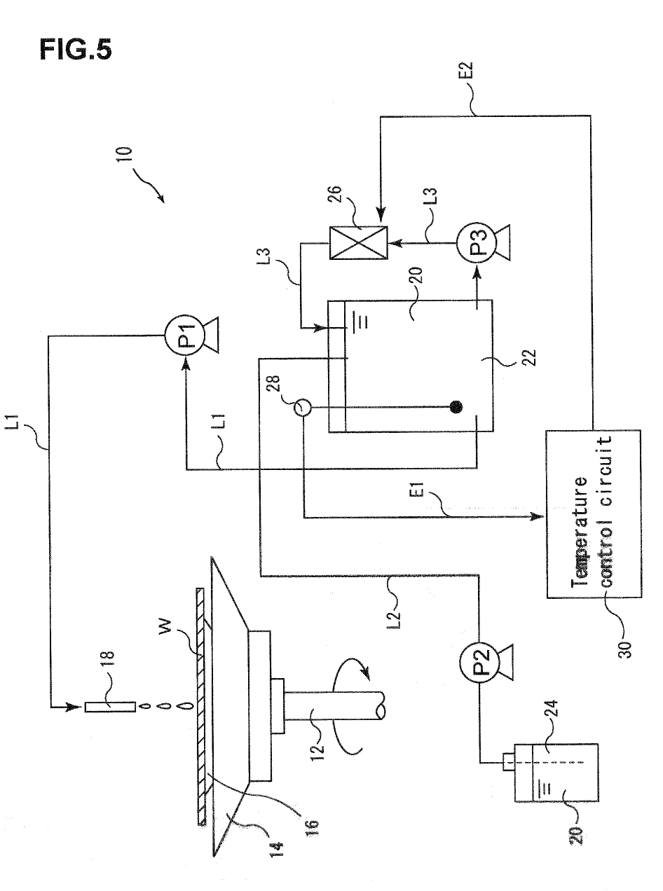

Hereinafter, an embodiment of the present invention will be described with reference to FIG. 1. The embodiment will be described as an example and various modifications can be made without departing from the technical idea of the present invention. In FIG. 1, components identical or similar to the components shown in FIG. 5 will be described with reference to the same reference symbols.

In FIG. 1, reference numeral 11 denotes a spin processing apparatus according to the present invention, for example, a spin etching apparatus, which includes a spin table 14 provided to be rotatable via a rotational shaft 12. A wafer holding means 16 for holding a wafer W is provided on an upper surface of the spin table 14. Reference numeral 18 denotes a chemical solution supply nozzle provided above the wafer holding means 16. The chemical solution supply nozzle 18 is connected with a chemical solution supply bottle 24 for storing an etching solution 20 through a connection pipe L4 to which a chemical solution pump P4 is provided. It is unnecessary to control a temperature of the etching solution 20 stored in the chemical solution supply bottle 24. However, the temperature may be adjusted to a predetermined temperature. FIG. 1 shows an example in which the temperature of the etching solution is not controlled.

Reference numeral 32 denotes a wafer heating means provided lateral to and above the spin table 14. Examples of the wafer heating means 32 include an air hot jet means or an N₂ hot jet means for pressuring and heating air or a nitrogen gas (N₂) and an infrared spot light means for emitting infrared light in a spot-shaped manner. As to be described later, a structure in which a heating member (heater) with which a temperature can be adjusted is provided in the wafer holding means 16 can be employed for the wafer heating processing means.

Reference numeral 34 denotes a wafer temperature detecting means, for example, an infrared radiation thermometer, which is provided lateral to and above the spin table 14 and opposed to the wafer heating means 32. The wafer temperature detecting means 34 is electrically connected with a temperature control circuit 30 through an electrical wire E3. The temperature control circuit 30 is electrically connected with the wafer heating means 32 through an electrical wire E4. The wafer heating means 32 is controlled based on a signal from the temperature control circuit 30, so the temperature of the wafer W can be adjusted to a predetermined temperature.

According to the above-mentioned structure, while the wafer W held on the spin table 14 by the wafer holding means 16 is heated to a predetermined temperature by the wafer heating means 32, the etching solution stored in the chemical solution supply bottle 24 is supplied to an upper surface of the wafer W, whereby predetermined spin etching processing is performed. In the spin etching processing, the temperature of the wafer W is continuously detected by the wafer temperature detecting means 34 and a detection temperature signal thereby is sent to the temperature control circuit 30. The wafer heating means 32 is controlled based on the signal from the temperature control circuit 30, so the wafer W is maintained at the predetermined temperature.

The example is described in which the wafer heating means 32 such as the air hot jet means, the N₂ hot jet means, or the infrared spot light means is separately provided as the wafer heating means 32 shown in FIG. 1. Another structure can be also employed in which the wafer holding means 16 is directly heated to heat the wafer W, which will be described below.

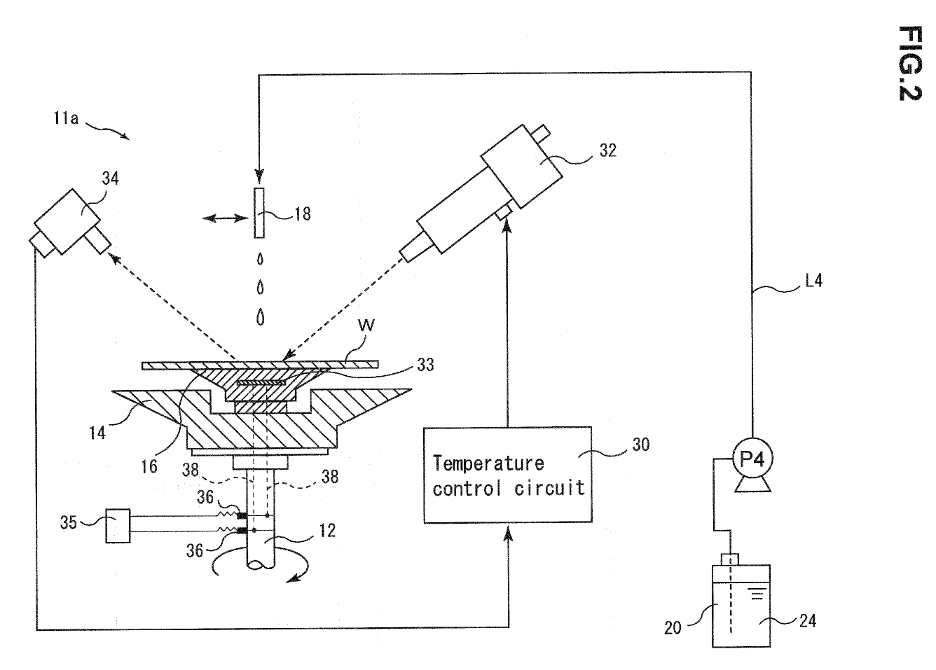

Another example of the processing apparatus according to the present invention will be described with reference to FIG. 2. In FIG. 2, components identical or similar to the components shown in FIG. 1 will be described with reference to the same reference symbols.

In FIG. 2, reference symbol Ha denotes a spin processing apparatus according to the present invention, for example, a spin etching apparatus, which includes the spin table 14 provided to be rotatable via the rotational shaft 12. The wafer holding means 16 for holding the wafer W is provided on the upper surface of the spin table 14.

Reference numeral 33 denotes a heating member (electrical heater) provided to the wafer holding means 16 for heating the wafer W. A current is supplied from an external power source 35 to the heating member 33 through power supply brushes 36, 36 and electrical wires 38, 38, so the wafer holding means 16 and the wafer W held and fixed by the wafer holding means 16 can be heated. Other structures are identical to those shown in FIG. 1 and thus the duplicated description is omitted here. According to the above-mentioned structure, the same operation and effect as those in the case where the wafer heating means 32 is separately provided as shown in FIG. 1 can be realized.

As described later in examples, the spin processing method and the spin processing apparatus according to the present invention is used to remove an oxide film from the surface of an Si wafer and can be applied to remove a resist film, an nitride film, or a metal film therefrom.

### EXAMPLE

Hereinafter, the present invention will be more specifically described by way of example. The example will be exemplary described and it is needless to say that the example should not be narrowly interpreted.

In this example, the wafer was thermally controlled by the hot jet heater using the N₂ gas employed as the wafer heating means and provided in the spin etching apparatus shown in FIG. 1.

### Experimental Example 1

A time necessary to remove a thermal oxide film from the surface of an Si wafer by hydrofluoric acid was measured at each changed hydrofluoric acid flow rate (L/min) to obtain a relation with an etching rate (Å/sec). The wafer was not heated by the wafer heating means. The completion of removal of the oxide film was visually checked based on the water repellency of a processed surface of the wafer.

An etching processing condition was as follows. A hydrofluoric acid concentration was 49.5%. A spin rotational speed was 1000 rpm. A chemical solution nozzle was positioned at the center of the wafer. A hydrofluoric acid temperature was 21° C.

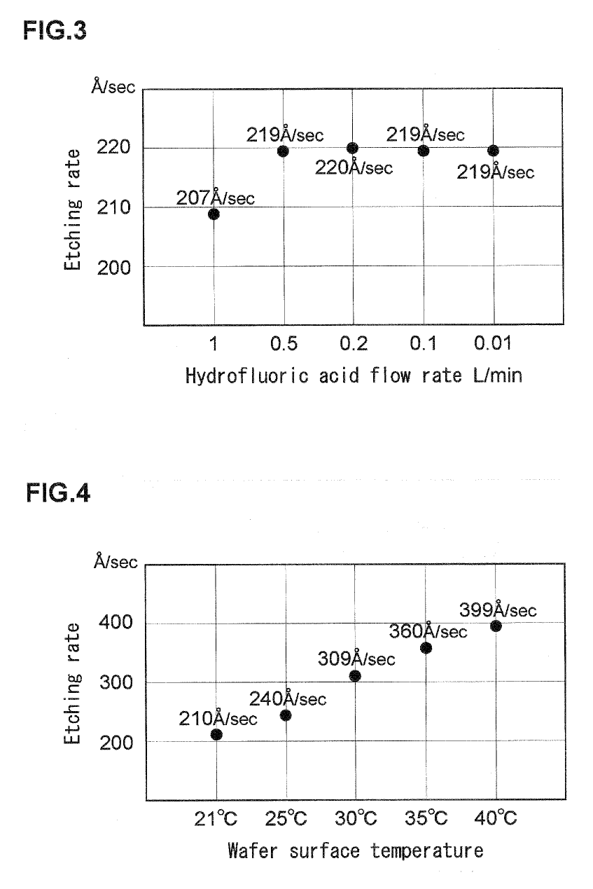

In the above-mentioned processing condition, as shown in FIG. 3, while the hydrofluoric acid flow rate was changed from 1 L/min to 0.01 L/min, whether or not there was a variation in etching rate to the hydrofluoric acid flow rate was checked. As a result, there was no variation in etching rate out of a range of 210 Å/sec to 220 Å/sec. Therefore, it was determined that the etching rate was not influenced by the variation in hydrofluoric acid flow rate.

### Experimental Example 2

The same processing condition as that in Experimental Example 1 was employed except for the fact that the hydrofluoric acid flow rate (L/min) was set to 0.01 L/min, the wafer was heated by the wafer heating means, and a wafer surface temperature was changed as shown in FIG. 4. The time necessary to remove the thermal oxide film from the surface of the Si wafer by hydrofluoric acid was measured to obtain a relation between the wafer surface temperature (° C.) and the etching rate (Å/sec). A result obtained by measurement is shown in FIG. 4. The completion of removal of the oxide film was checked as in Experimental Example 1.

In the above-mentioned processing condition, as shown in FIG. 4, the etching rate was increased by a rise in wafer surface temperature. Therefore, it is determined that the etching rate increases as the wafer surface temperature rises.

### INDUSTRIAL APPLICABILITY

According to the present invention, the use efficiency of the chemical solution is improved in the spin processing such as the spin etching processing or the spin washing processing, whereby an amount of the chemical solution to be used can be significantly reduced and the chemical solution supply circuit can be simplified to reduce a cost.

1. A spin processing method comprising holding and fixing a wafer on an upper surface of a spin table, and supplying a processing solution to a surface of the wafer by a predetermined amount while rotating the spin table, to process the surface of the wafer, wherein the processing solution is supplied while the wafer is heated and maintained at a predetermined temperature, to process the wafer.

2. The spin processing method according to claim 1, wherein the predetermined temperature for heating the wafer is equal to or higher than 25° C.

3. The spin processing method according to claim 1, wherein an amount of processing solution to be supplied is 1 L/min to 0.005 L/min.

4. A pin processing apparatus, comprising:
a spin table rotatably provided and including wafer holding means on an upper surface thereof;
a chemical solution supply nozzle for supplying a processing solution to the upper surface of the spin table;
a wafer heating means for heating a wafer held and fixed on the upper surface of the spin table;
a wafer temperature detecting means for detecting a temperature of the wafer; and
a temperature control circuit for controlling the wafer heating means based on a detection temperature signal from the wafer temperature detecting means.

5. The spin processing apparatus according to claim 4, wherein the wafer heating means is an N₂ hot jet means for spraying a pressurized and heated nitrogen gas.

6. The spin processing apparatus according to claim 4, wherein the wafer heating means is an air hot jet means for spraying pressurized and heated air.

7. The spin processing apparatus according to claim 4, wherein the wafer heating means is an infrared spot light means for emitting infrared light in a spot-shaped manner.

8. The spin processing apparatus according to claim 4, wherein the wafer heating means comprises a heating member provided in the wafer holding means, with which a temperature can be adjusted.

9. The spin processing method according to claim 2, wherein an amount of processing solution to be supplied is 1 L/min to 0.005 L/min.
